(19) United States
(12) Patent Application Publication
(10) Pub. No.: US 2018/0349051 A1
(43) Pub. Date: Dec. 6, 2018

(54) ALLOCATING COHERENT AND NON-COHERENT MEMORIES

(71) Applicant: Hewlett Packard Enterprise Development LP, Houston, TX (US)

(72) Inventors: Alexandros Alexandros, Palo Alto, CA (US); Paolo Faraboschi, Sant Cugat (ES)

(21) Appl. No.: 15/776,473

(22) PCT Filed: Feb. 5, 2016
(86) PCT No.: PCT/US2016/016759

§ 371 Date: May 16, 2018

(51) Int. Cl. G06F 3/06; G06F 12/0815

(52) U.S. Cl. CPC G06F 3/0631; G06F 3/0604; G06F 2212/1032; G06F 12/0815; G06F 3/0673

(57) ABSTRACT

A computing device includes a coherence controller and memory comprising a coherent memory region and a non-coherent memory region. The coherence controller may: determine a coherent region of the memory, determine a non-coherent region of the memory, and responsive to receiving a memory allocation request for a block of memory in the memory: allocate, based on a received memory allocation request for a memory block, the requested block of memory in the non-coherent memory region or the coherent memory region based on whether the memory allocation request indicates the requested block is to be coherent or non-coherent.

### BACKGROUND

Computing devices may comprise large amounts of memory, which may be shared among a large number of processors.

### BRIEF DESCRIPTION OF THE DRAWINGS

Certain examples are described in the following detailed description and in reference to the drawings, in which:

FIG. 1 is a conceptual diagram of an example computing device that may allocate memory;

FIG. 2 is another conceptual diagram of an example computing device of an example computing system that may allocate memory;

FIG. 3 is a flowchart of an example method for allocating memory;

FIG. 4 is a flowchart of an example method for allocating memory; and

FIG. 5 is a block diagram of an example for allocating memory.

### DETAILED DESCRIPTION

Next-generation computing devices may have hundreds or thousands of cores and terabytes or petabytes of RAM (random access memory), as well as large amounts of non-volatile memory, which the cores may share. Enabling volatile and/or non-memory to be coherent across multiple accessing processors or cores is a challenge associated with architectures having large amounts of shared memories. Making the entire large pool of memory fully coherent may result in huge performance penalties and therefore may be undesirable.

On the other hand, offering solely non-coherent memory adds programming challenges to such systems. More particularly, a programmer wishing to have some coherent portion of a shared memory pool has to manually ensure that the coherent region of memory is coherent, i.e. that data is flushed and/or invalidated from local and remote caches to guarantee coherent behavior. Manual coherence management may also have negative impacts on performance and power consumption of shared memory systems.

Additionally, programmers may rely on the contents of memory, especially non-volatile memory, to be persistent. A fully coherent memory layer may jeopardize the persistence of memory locations due to the occurrence of cache-to-cache transfers, which may be used to reduce the speed of inter-node transfers, e.g. in non-uniform memory architecture (NUMA) systems. After an inter-node cache-to-cache transfer, data may reside in a cache rather than in memory, which may cause data written in memory to later be overwritten when the cache-to-cache transfer is flushed to memory.

This disclosure is directed to software-defined coherence of the memory layer. Based on a use case, software may control whether a region of allocated memory is allocated as coherent or non-coherent. A coherence controller within a computing system may allocate and manage coherent and non-coherent regions of memory. The coherence controller may also ensure that multiple processors coherently access the coherent memory region in accordance with a memory coherence protocol.

This disclosure is directed to flexible and controllable coherence of the memory layer. According to this disclosure, a coherence controller of a computing device may receive a request to allocate a block of memory. The memory allocation request may indicate whether the requested region is to be allocated as coherent or non-coherent. Responsive to receiving the allocation request, the coherence controller may allocate the block of memory in a coherent region of memory or a non-coherent region of the memory based on indication in the memory allocation request.

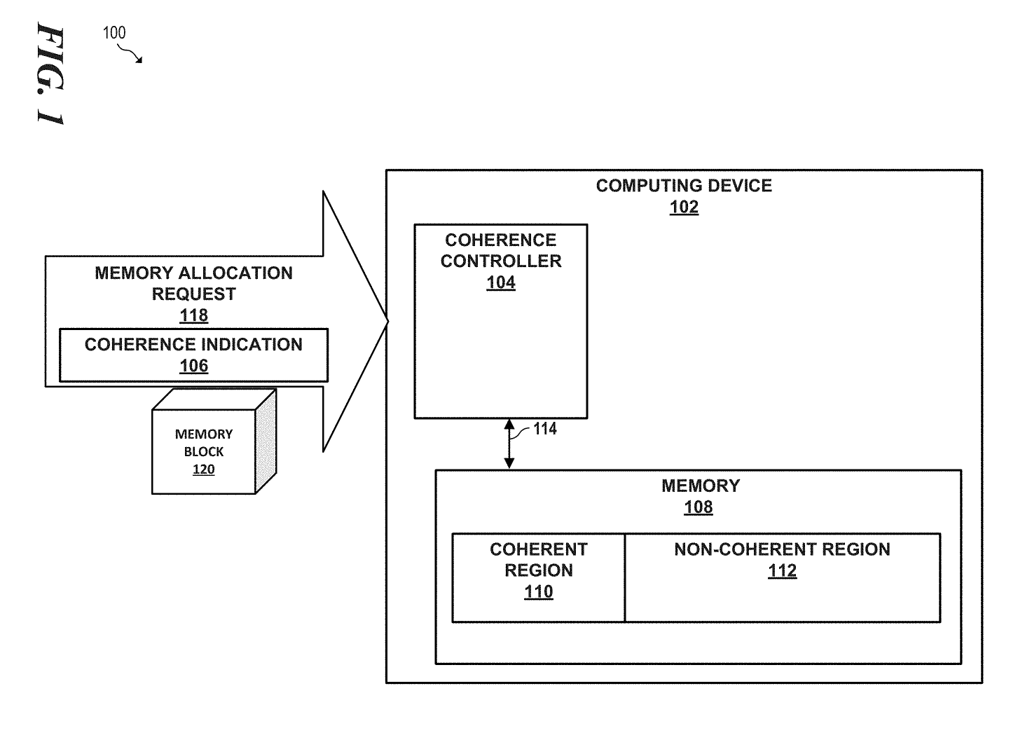

FIG. 1 is a conceptual diagram of an example computing device that may allocate memory. FIG. 1 illustrates computing system 100, which comprises a computing device 102. Computing device 102 may comprise a central processing unit (CPU), system on a chip (SoC), memory controller, application-specific integrated circuit (ASIC), field programmable gate array, the like, and/or any combination thereof.

Computing device 102, comprises coherence controller 104, and memory 108. Coherence controller 104 and memory 108 may be coupled via an interconnect 114. Interconnect 114 may comprise a bus, such as a memory bus, PCIe bus, or the like. Memory 108 may comprise any type of volatile and/or non-volatile memory such as synchronous RAM (SRAM), dynamic RAM (DRAM), NAND flash, memristors, resistive RAM, or the like. As will be described in greater detail herein, coherence controller 104 may determine a coherent region 110 of memory 108 and/or a non-coherent region 112 of memory 108. As described in greater detail herein, the sizes of coherent region 110 and non-coherent region 112 may be variable.

Computing device 102 may receive a memory allocation request 118 to allocate a memory block 120 in memory 108. A processor, such as a CPU may generate memory allocation request 118. Memory allocation request 118 may indicate a requested size (e.g., in number of bytes) for memory block 120. Additionally, memory allocation request 118 may indicate whether memory block 120 is requested to be coherent or non-coherent.

In some examples, Memory allocation request 118 comprise a function that may be called in software, such as the malloc( ) function of the C programming language standard library. In various examples, the malloc( ) function may be extended to include a value that indicates whether a block that is being requested to be allocated, is requested to be coherent or non-coherent. As an example, the function may have the signature: void*malloc(size_t size, boot is_coherent), where size indicates a size to be allocated for the block in bytes, and is_coherent indicates whether the block is to be coherent or not.

Responsive to receiving a memory allocation request, a processor, such as a CPU executing an operating system (OS), may signal coherence controller 104 to allocate space for memory block 120 in memory 108. Coherence controller 108 may determine whether coherence indication 110 of memory allocation request 118 indicates that memory block 120 is requested to be coherent or non-coherent.

If coherence indication 106 indicates that memory block 120 is requested to be coherent, coherence controller 104 determines whether there is sufficient space to allocate memory block 120 in coherent region 110. If coherence indication 110 indicates that memory block is requested to be non-coherent, coherence controller 104 determines whether there is sufficient space to allocate memory block 120 in non-coherent memory region 112.

If sufficient space is available in coherent region 110 for a requested coherent memory block, or sufficient space is available in non-coherent region 112 for a non-coherent memory block, coherence controller 104 allocates space for memory block 120. Coherence controller 104 may then signal a reference (e.g., an address or pointer) to the allocated block within memory 108. If sufficient space is not available within memory 108, coherence controller 104 may signal that the memory allocation has failed.

In this manner, computing device 102 may represent an example computing device comprising a memory 108, and a coherence controller 104. Coherence controller 104 may determine a coherent region (110) of memory 108, and determine a non-coherent region (112) of memory 108 that is coherent. Coherence controller 104 may further, responsive to receiving a memory allocation request 118, for a block of memory 120 in memory 108: based on a received memory allocation request for the memory block 120, allocate the requested block of memory 120 in the non-coherent region 112 or allocate the requested block of memory 120 in the coherent region 110 based on whether the memory allocation request indicates the requested block is to be coherent or non-coherent.

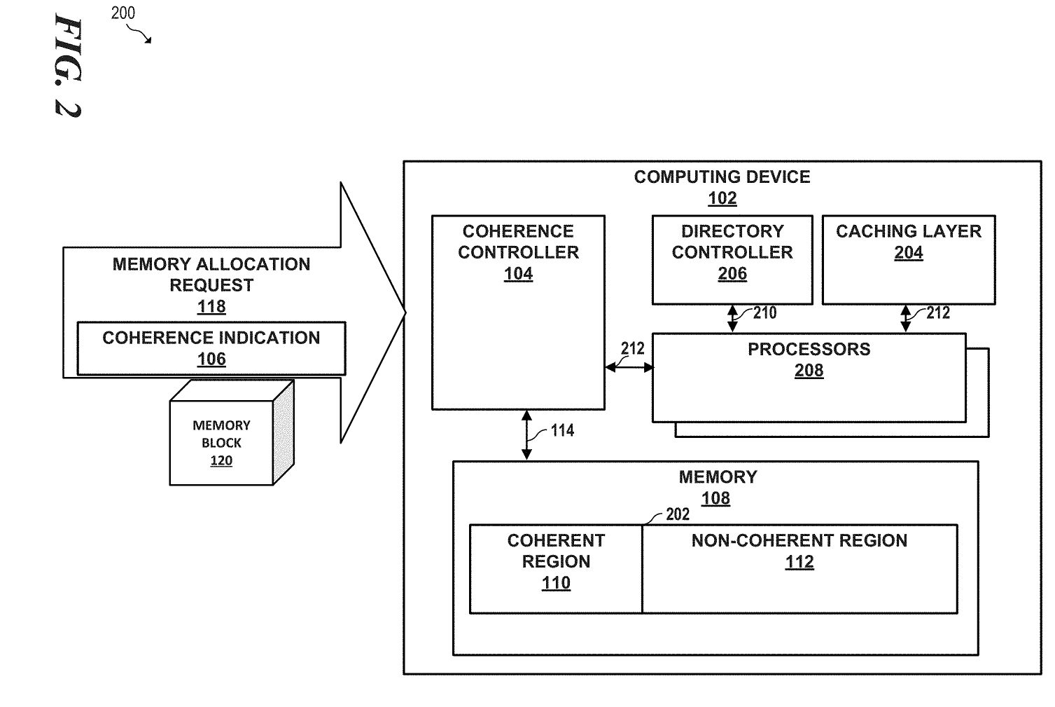

FIG. 2 is another conceptual diagram of an example computing device that may allocate memory. FIG. 2 illustrates a computing system 200. In various examples, computing system 200 may be similar to computing system 100 (FIG. 1). Computing system 200 comprises computing device 102 and memory allocation request 118.

In the various examples illustrated of FIG. 2, computing device 102 may further comprise a caching layer 204, directory controller 206, which may be coupled with processors 208 via an interconnect 210. Processors 208 may execute an operating system and may be coupled with coherence controller 104 and/or memory 108 e.g. via interconnects 212. In various examples, processors 208 may be coupled with caching layer 204

Processors 208 may comprise multiple physical dies, cores, ASICs, FPGAs, and/or SoCs. Processors 208 may be coupled with coherence controller 104, directory controller, 206, caching layer 204, and/or memory 108 via a fabric in various examples. In various examples, coherence controller 104 may be integrated with processors 208.

In various examples, each of processors 208 may each be coupled with a local memory, such as memory 108. Each processor may access a non-local memory using directory controller 206. Directory controller may maintain coherence information about memory 108. In various examples, directory controller 206 may not maintain information about other non-local memories. In various examples, directory controller 206 may maintain coherence of coherent region 110 in accordance with a memory coherence protocol, such as MOSI (modified, owned, shared, invalid), MOESI (modified, owned, exclusive, shared, invalid), or the like. In various examples, the coherence protocol may be a snooping protocol or a snarling protocol.

As described above, coherence controller 104 may determine sizes of coherent region 110 and non-coherent region 112 of memory 108. In some examples coherence controller 104 may determine a size of memory 108 based on the addressing capabilities of directory controller 206.

In various examples, directory controller 206 may comprise a full directory that is capable of accessing the entire address range of memory 108 comprising all of coherent region 110 and non-coherent region 112. In this example, coherence controller 104 may determine the maximum size of coherent region 110 as being equal to the entire range of memory 108.

In some examples, directory controller 206 may comprise a partial directory that is capable of addressing and ensuring coherence for an address range of memory 108 that is less than the whole address range of memory 108. In this example, coherence controller 104 may determine a maximum size of coherent region 110 equal to the maximum coherent address range accessible to directory controller 206.

Caching layer 204 may cache various accesses to memory 108 from processors 208. Caching layer 204 may perform caching to speed inter-node transfers, as described above. Data values stored in caching layer 204 may not be immediately flushed or committed to memory 108 in some cases. In various examples, coherence controller 104 may determine a size of caching layer 204, and based on the size of caching layer 204, may determine a maximum size of coherent region 110 as being equal to the size of caching layer 204.

In various examples, coherence controller 104 may determine the sizes of coherent region 110 and non-coherent region 112 at boot-time. In some cases, coherence controller 104 may determine an address boundary 202 of coherent region 106 and non-coherent region 112 at boot-time. Based on the determined address boundary 202, and coherence indication 106, coherence controller 104 may allocate requested memory block 120 into coherent region 110 or non-coherent region 112.

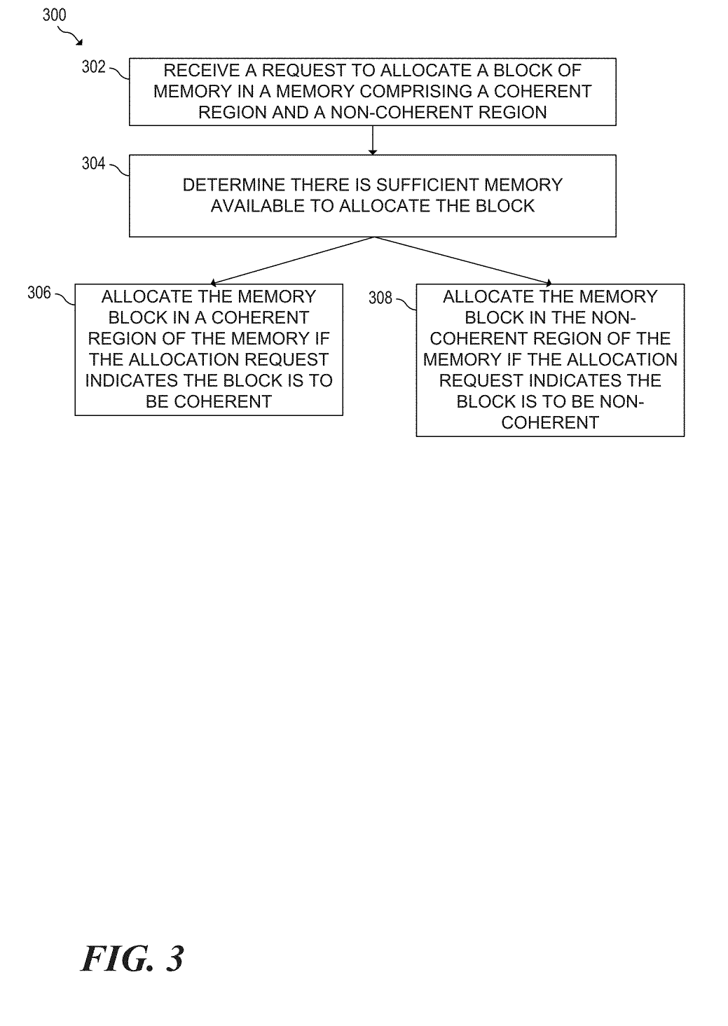

FIG. 3 is a flowchart of an example method for allocating memory. Method 300 may be described below as being executed or performed by a system, for example, computing system 100 (FIG. 1) or computing system 200 (FIG. 2). In various examples, method 300 may be performed by hardware, software, firmware, or any combination thereof. Other suitable systems and/or computing devices may be used as well. Method 300 may be implemented in the form of executable instructions stored on at least one machine-readable storage medium of the system and executed by at least one processor of the system. Alternatively or in addition, method 300 may be implemented in the form of electronic circuitry (e.g., hardware). In alternate examples of the present disclosure, one or more blocks of method 300 may be executed substantially concurrently or in a different order than shown in FIG. 3. In alternate examples of the present disclosure, method 300 may include more or fewer blocks than are shown in FIG. 3. In some examples, one or more of the blocks of method 300 may, at certain times, be ongoing and/or may repeat.

Method 300 may start at block 302 at which point the computing system, e.g. computing system 100 may receive a request (e.g. memory allocation request 118) to allocate a block of memory (e.g. memory block 120) in a memory (e.g. memory 108). The memory may comprise a coherent region (e.g. coherent region 110) and a non-coherent region (e.g. non-coherent region 112). The memory allocation request may indicate (e.g. via coherence indication 106) whether the requested memory block 120 is to be allocated as coherent or non-coherent.

At block 304, coherence controller 104 may determine whether there is sufficient memory available to allocate memory block 120. At block 306, responsive to determining that there is sufficient memory available to allocate memory block 120, coherence controller 104 may allocate memory block 120 in coherent region 110 if memory allocation request 118 indicates the block 120 is to be coherent.

Method 300 may proceed to block 308, where coherence controller may proceed to allocate memory block 120 in non-coherent region 112 as a non-coherent block if memory allocation request 118 indicates memory block 120 is to be non-coherent.

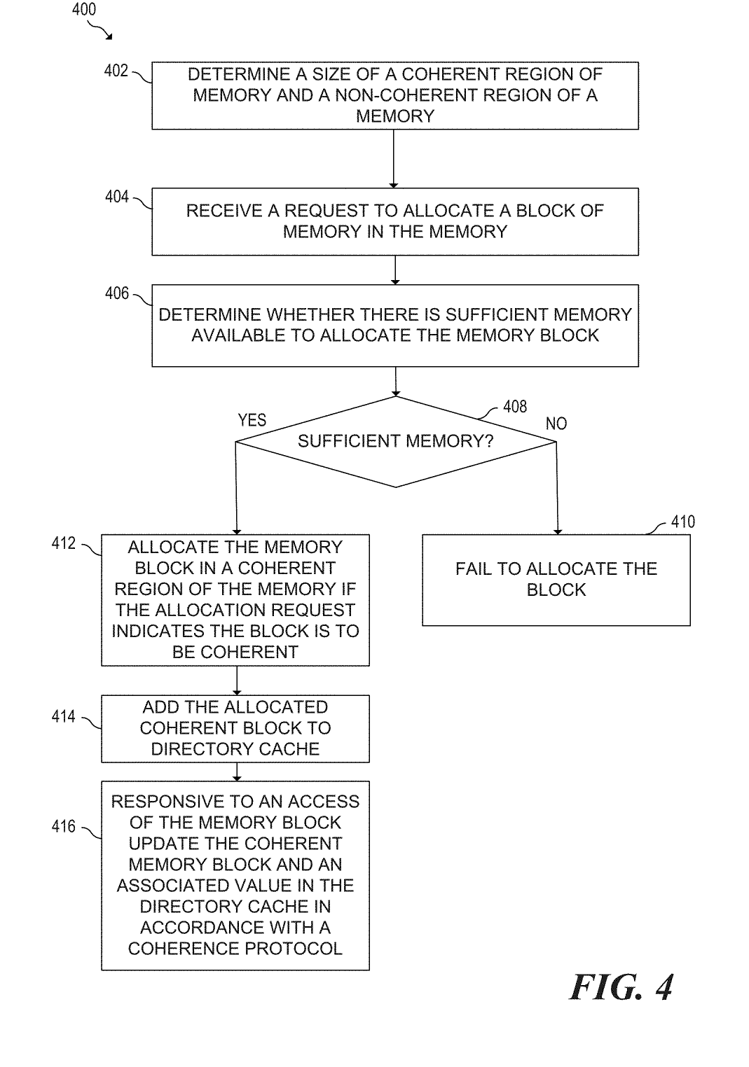

FIG. 4 is a flowchart of an example method for allocating memory. FIG. 4 illustrates method 400. Method 400 may be described below as being executed or performed by a system, for example, computing system 100 (FIG. 1) or computing system 200 (FIG. 2). Other suitable systems and/or computing devices may be used as well. Method 400 may be implemented in the form of executable instructions stored on at least one machine-readable storage medium of the system and executed by at least one processor of the system. Method 400 may be performed by hardware, software, firmware, or any combination thereof.

Alternatively or in addition, method 400 may be implemented in the form of electronic circuitry (e.g., hardware). In alternate examples of the present disclosure, one or more blocks of method 400 may be executed substantially concurrently or in a different order than shown in FIG. 4. In alternate examples of the present disclosure, method 400 may include more or fewer blocks than are shown in FIG. 4. In some examples, one or more of the blocks of method 400 may, at certain times, be ongoing and/or may repeat.

In various examples, method 400 may start at block 402 at which point coherence controller 104 may determine a size of a coherent region (e.g. coherent region 110) of a memory (e.g., memory 108), and a size of a non-coherent region (e.g. non-coherent region 112) of memory 108. In some examples, coherence controller 104 may determine a size of coherent region 110 and non-coherent region 112 based on a size of caching layer 204. In various examples, the size of coherent region 110 and non-coherent region 112 at boot time.

Method 400 may proceed to block 404 at which point coherence controller 104 may receive a request (e.g. via memory allocation request 118) to allocate a block of memory (e.g. memory block 120) in memory 108. The memory allocation request may indicate (e.g. via coherence indication 106) whether the requested memory block 120 is to be allocated as coherent or non-coherent.

At block 406, coherence controller 104 may determine whether there is sufficient memory available to allocate memory block 120. Method 400 may then proceed to decision block 408. In some examples, if there is not sufficient memory available to allocate memory block 120 (“No branch of decision block 408), method 400 may proceed to block 410, where coherence controller 104 may fail to allocate memory block 120.

At block decision 408, if coherence controller 104 determines that that there is sufficient memory available to allocate memory block 120 (“yes” block of decision block 408), method 400 may proceed to block 412, and coherence controller 104 may allocate memory block 120 in coherent region 110 as a coherent block if memory allocation request 118 indicates the block 120 is to be coherent.

In various examples, after performing block 412, method 400 may proceed to block 414, at which point coherence controller 104 may add the allocated memory block 120 to directory controller 206. At block 416, responsive to processors (e.g. processors 208) accessing the coherent memory block, coherence controller 104 may update the coherent memory block and an associated value in directory controller 206 in accordance with a coherence protocol, such as MOSI or MOESI in various examples.

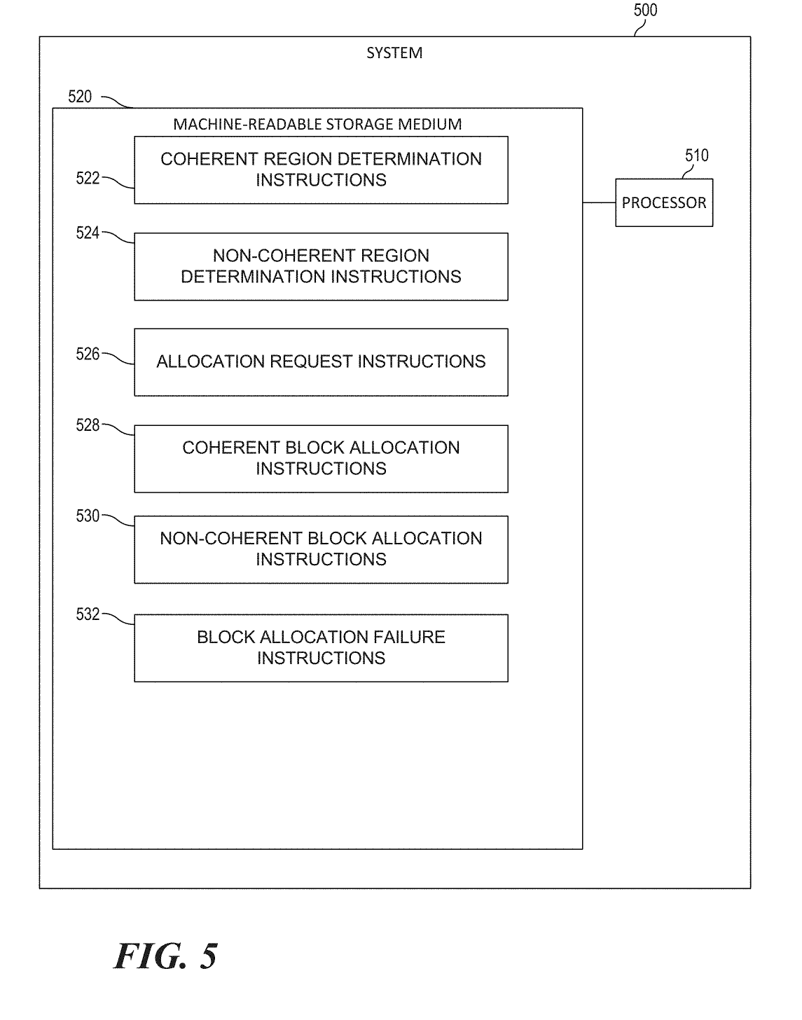

FIG. 5 is a block diagram of an example for allocating memory. In the example of FIG. 5, system 500 includes a processor 510 and a machine-readable storage medium 520. Although the following descriptions refer to a single processor and a single machine-readable storage medium, the descriptions may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 510 may be one or more central processing units (CPUs), microprocessors, and/or other hardware devices suitable for retrieval and execution of instructions stored in machine-readable storage medium 520. In some examples, processor 510 may comprise one or more of processors 208 (FIG. 2). In the particular example shown in FIG. 5, processor 510 may fetch, decode, and execute instructions 522, 524, 526, 528, 530, 532 to allocate memory.

As an alternative or in addition to retrieving and executing instructions, processor 510 may include one or more electronic circuits comprising a number of electronic components for performing the functionality of one or more of the instructions in machine-readable storage medium 520. With respect to the executable instruction representations (e.g., boxes) described and shown herein, it should be understood that part or all of the executable instructions and/or electronic circuits included within one box may, in alternate examples, be included in a different box shown in the figures or in a different box not shown.

Machine-readable storage medium 520 may be any electronic, magnetic, optical, or other physical storage device that stores executable instructions. Thus, machine-readable storage medium 520 may be, for example, Random Access Memory (RAM), an Electrically-Erasable Programmable Read-Only Memory (EEPROM), a storage drive, an optical disc, and the like. Machine-readable storage medium 520 may be disposed within system 500, as shown in FIG. 5. In this situation, the executable instructions may be “installed” on the system 500. Alternatively, machine-readable storage medium 520 may be a portable, external or remote storage medium, for example, that allows system 500 to download the instructions from the portable/external/remote storage medium.

Referring to FIG. 5, coherent region determination instructions 522, when executed by a processor (e.g., 510), may cause processor 510 to determine a coherent region of a memory (e.g. coherent region 110 of memory 108). Non-coherent region determination instructions 524, if executed, may cause processor 510 to determine a non-coherent region of the memory (e.g. non-coherent region 108).

In some examples, processor 510 may execute allocation request instructions 526 in various examples. Allocation request instructions 526, if executed, may cause processor 510 to receive a request (e.g. memory allocation request 110) to allocate a block (e.g. memory block 120) within the memory, wherein the request indicates whether the block is to be coherent or non-coherent (e.g., coherence indication 106).

Responsive to receiving the memory allocation request, processor 510 may execute coherent block allocation instructions 528, which, when executed, cause processor 510 to allocate the block in the coherent region if the request indicates the block is to be coherent and there is sufficient space in the coherent region of the memory.

In some examples, to allocate the block in the coherent region, processor 510 may allocate the block to be coherent among a plurality of processors, e.g. processors 208 which are coupled with the memory. Memory block 120 may further be coherent in accordance in accordance with a coherence protocol. In various examples, the allocated coherent block may be stored in a directory controller (e.g. directory controller 206) in accordance with a directory coherence protocol.

In some examples, responsive to receiving the memory allocation request, processor 510 may execute non-coherent block allocation instructions 530, which, when executed, cause processor 510 to allocate the block in the non-coherent region if the request indicates the block is to be in the non-coherent region.

In some examples, e.g. if there is insufficient space in the coherent region, and the block is requested to be coherent, processor 510 may execute block allocation failure instructions 532, which if executed, cause processor 510 to fail to allocate the block.

1. A method comprising:
receiving a request to allocate a block of memory in a memory, the memory comprising a coherent region and a non-coherent region,
wherein the memory allocation request indicates whether the requested memory block is to be allocated as coherent or non-coherent;
responsive to determining that there is sufficient memory available to allocate the memory block:
allocating the memory block in the coherent region as a coherent block if the allocation request indicates the block is to be coherent; and
allocating the memory block in the non-coherent region as a non-coherent block if the allocation request indicates the block is to be non-coherent.

2. The method of claim 1, further comprising:
responsive to determining that there is insufficient space in the memory to allocate the block, failing to allocate the memory block.

3. The method of claim 1, wherein allocating the memory block in the memory as coherent comprises:
adding the allocated coherent memory block to a directory controller; and
responsive to accessing the coherent memory block, updating the coherent memory block and an associated value in the directory controller in accordance with a coherence protocol.

4. The method of claim 1, further comprising: determining a size of a coherent region of the memory and a size of a non-coherent region of the memory at boot time.

5. The method of claim 1, further comprising:
determining a size of the coherent region and the non-coherent region based on a size of a caching layer for the coherent region.

6. The method of claim 1, wherein the memory allocation request comprises a malloc( ) function, wherein the malloc( ) function indicates whether the memory region to be allocated is to be volatile or non-volatile.

7. A computing device comprising:
a memory comprising a coherent memory region and a non-coherent memory region; and
a coherence controller, the coherence controller to:
determine a coherent region of the memory;
determine a non-coherent region of the memory; and
responsive to receiving a memory allocation request for a block of memory in the memory:
allocate; based on a received memory allocation request for a memory block, the requested block of memory in the non-coherent memory region or the coherent memory region based on whether the memory allocation request indicates the requested block is to be coherent or non-coherent.

8. The computing device of claim 7, the coherence controller further to:
determine, at boot time, an address boundary of the coherent memory region and an address boundary for the non-coherent region; and
allocate the requested memory region to be allocated based on the address boundary and whether the

9. The computing device of claim 7, further comprising a caching layer associated with the coherent region,
the coherence controller further to:
determine a maximum size of the coherent region is based on a size of the caching layer.

10. The computing device of claim 7, further comprising a directory controller to coherently access a range of the memory,
the coherence controller further to:
determine a maximum size of the coherent region equal to the coherent range accessible by the directory cache controller.

11. The computing device of claim 7, further comprising a directory controller,
wherein the directory controller comprises a full directory capable of accessing an entire range of the coherent region,
the coherence controller further to:
determine a maximum size of the coherent region as being equal the entire range of the memory.

12. The computing system of claim 7, further comprising:
a plurality of processors,
wherein the coherence controller further to:
receive accesses from the plurality of processors to the coherent region; and
ensure accesses to the coherent region are coherent in accordance with a memory coherence protocol.

13. A non-transitory machine-readable storage medium encoded with instructions, the instructions that, when executed, cause a processor to:
determine a coherent region of a memory;
determine a non-coherent region of the memory;
receive a request to allocate a block within the memory, wherein the request indicates whether the block is to be coherent or non-coherent;
responsive to receiving the memory allocation request:
allocate the block in the coherent region if the request indicates the block is to be coherent and there is sufficient space in the coherent region of the memory;
allocate the block in the non-coherent region if the request indicates the block is to be in the non-coherent region; and
fail to allocate the block if there is insufficient space in the coherent region and the block is requested to be coherent.

14. The non-transitory computer-readable storage medium of claim 13,
wherein the allocated coherent block is coherent among a plurality of processors coupled with the memory, and wherein the block is coherent in accordance with a coherence protocol.

15. The non-transitory computer-readable storage medium of claim 13,
wherein the allocated coherent block is stored in a directory controller in accordance with a directory coherence protocol.
